(19) United States
(12) Patent Application Publication
(10) Pub. No.: US 2001/0007994 A1
(43) Pub. Date: Jul. 12, 2001

(54) Internet microwave oven

(75) Inventor: Ji Woong Kim, Pusan-shi (KR)

Correspondence Address: FLESHNER & KIM, P.O Box 221200, Chantilly, VA, 20153-1200, US

(73) Assignee: LG Electronics Inc.

(21) Appl. No.: 09/740,846

(22) Filed: Dec. 21, 2000

(30) Foreign Application Priority Data
Jan. 12, 2000 (KR) 2000/1372

(51) Int. Cl. G06F 15/16

(52) U.S. Cl. 709/208; 709/203

(57) ABSTRACT

An Internet microwave oven is disclosed, which is directly connected with Internet without a PC so that a user cooks food using cooking information on the Internet. The Internet microwave oven includes an access unit connected to a communication line, for accessing Internet, a search engine for searching cooking information and other various information when the Internet is accessed through the access unit, a microcomputer for downloading the cooking information and other various information searched by the search engine at a user's request or for outputting a control signal to cook food depending on the cooking information selected by the user, a signal converting unit for converting the cooking information and other various information searched by the search engine to a signal capable of being recognized by the microcomputer to perform data communication with the microcomputer, and a display unit for displaying the cooking information and other various information converted by the signal converting unit in accordance with the control signal of the microcomputer.

### BACKGROUND OF THE INVENTION

1. Field of the Invention

The present invention relates to a microwave oven, and more particularly, to an Internet microwave oven which is directly connected with Internet so that a user variously utilizes the oven.

2. Description of the Related Art

Generally, a microwave oven is a cooking machine which unfreezes frozen food or heats cool food. It is understood that the microwave oven is the most fundamental core element most widely used in the kitchen.

Unlike it was before, the kitchen tends to a main living space where family members have a conversation with one another during a meal. In this respect, the microwave oven, which is a main element in the kitchen, requires functional transformation quantitatively as well as qualitatively, so that the family members easily utilize it.

A related art Internet microwave oven will be described with reference to the accompanying drawings.

FIG. 1 is a block diagram showing a configuration of the related art Internet microwave oven.

As shown in FIG. 1, the related art Internet microwave oven includes a PC 1 for providing cooking data, a repeater 2 for downloading the cooking data from the PC 1, and a microwave oven 3 for cooking food in accordance with the cooking data transmitted from the repeater 2.

The PC 1 is connected to Internet to download cooking information on the Internet, thereby providing various cooking information. In case that a user desires to cook food utilizing the cooking information on the Internet, the user connects the PC 1 to the Internet to allow the repeater to download desired cooking data. Subsequently, the microwave oven 3 extracts desired cooking data from the repeater 2 to cook a corresponding food.

However, the aforementioned related art Internet microwave oven has several problems.

First, to utilize cooking information on the Internet, the repeater and the PC for access to the Internet should be provided. This increases additional costs for access to the Internet. Furthermore, since it is necessary to access the Internet through multi-level access, any inconvenience may be given to the user. Finally, utilization of the Internet for other information in addition to cooking information is impossible in the related art microwave oven.

### SUMMARY OF THE INVENTION

Accordingly, the present invention is directed to an Internet microwave oven that substantially obviates one or more of the problems due to limitations and disadvantages of the related art.

An object of the present invention is to provide an Internet microwave oven which is directly connected with Internet without a PC so that a user cooks food using cooking information on the Internet.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an Internet microwave oven according to the present invention includes an access unit connected to a communication line, for accessing Internet, a search engine for searching cooking information and other various information when the Internet is accessed through the access unit, a microcomputer for downloading the cooking information and other various information searched by the search engine at a user's request or for outputting a control signal to cook food depending on the cooking information selected by the user, a signal converting unit for converting the cooking information and other various information searched by the search engine to a signal capable of being recognized by the microcomputer to perform data communication with the microcomputer, and a display unit for displaying the cooking information and other various information converted by the signal converting unit in accordance with the control signal of the microcomputer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing the related art Internet microwave oven;

FIG. 2 is a block diagram showing an Internet microwave oven according to the present invention;

FIG. 3 is a block diagram showing data communication between a search engine and a microcomputer of FIG. 2; and

FIG. 4 shows signal waveforms showing data communication between a signal converting unit and the microcomputer.

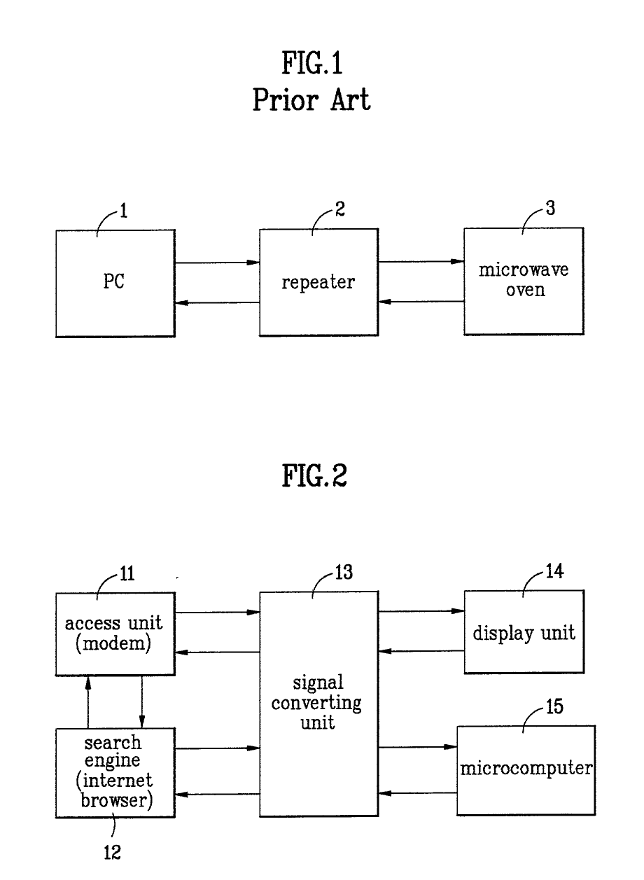

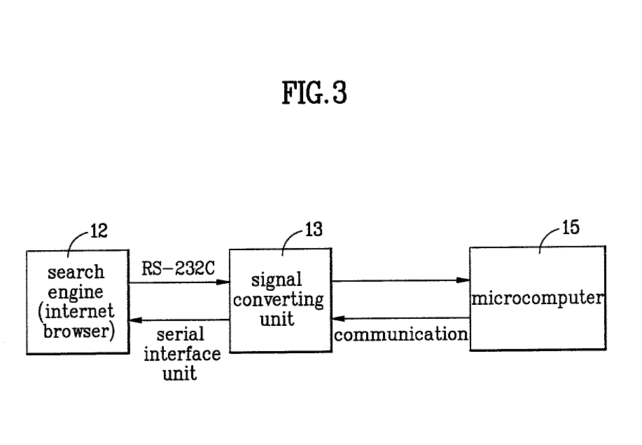

### DETAILED DESCRIPTION OF THE PREFERRED EMBODIMENTS

Reference will now be made in detail to the preferred embodiments of the present invention, examples of which are illustrated in the accompanying drawings.

As shown in FIG. 2, an Internet microwave oven according to the present invention includes an access unit 11 connected to a communication line, for accessing Internet, a search engine 12 for searching information when the Internet is accessed through the access unit 11, a display unit for displaying the information searched by the microcomputer 15 for outputting a control signal to cook a corresponding food referring to the information searched by the search engine 12 at a user's request, and a signal converting unit 13 for converting the information searched by the search engine 12 to a signal capable of being recognized by the microcomputer 15.

The operation of the aforementioned Internet microwave oven according to the present invention will be described below.

If the user desires to search cooking information through Internet access, the microcomputer 15 starts to access the Internet through the signal converting unit 13. Thus, the signal converting unit 13 accesses the search engine 12 to perform data communication.

Various information searched by the search engine 12 are transmitted to the signal converting unit 13. The signal converting unit 13 converts the various information searched by the search engine 12 to a signal capable of being recognized by the microcomputer 15, and transmits the converted signal to the microcomputer 15.

The signal transmitted to the microcomputer 15 is displayed in the display unit 14 to be viewed by the user. Referring to this signal, the user can cook a corresponding food.

That is, if the user selects the Internet access, the microwave oven is connected to a communication line through the access unit 11 which is connected to the communication line, and the search engine 12 is driven to access the Internet. If the Internet is accessed, the display unit 14 displays window environments connected to the Internet.

At this instance, the user downloads desired cooking information referring to the information displayed in the display unit 14. The downloaded cooking information is input to the microcomputer 15 through the signal conversion by the signal converting unit 13.

Then, if the user selects a cooking start button, the microwave oven is controlled to complete the corresponding food referring the cooking information downloaded through the Internet.

Furthermore, in addition to the cooking information, the user downloads other various information through the Internet so that the downloaded information can be displayed in the display unit.

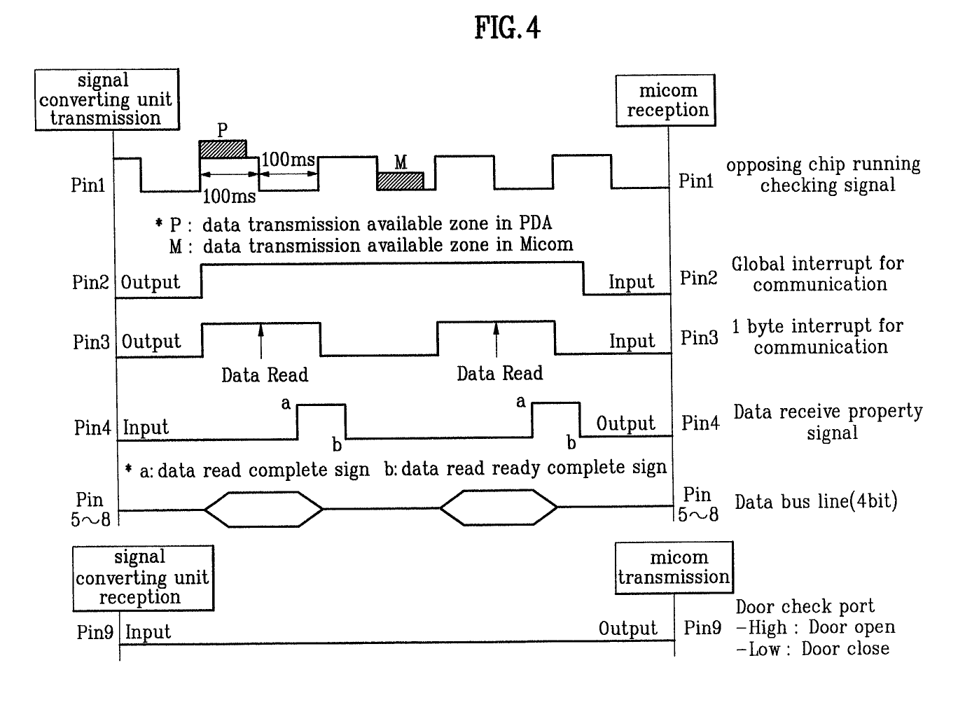

The data communication step between the signal converting unit 13 and the microcomputer 15 will now be described with reference to FIG. 4.

The data communication between the signal converting unit 13 and the microcomputer 15 is performed through first to ninth ports Pin1˜Pin9. The first port is a signal port to sense whether the signal converting unit 13 is in operation state. The second port is a global interrupt port for communication while the third port is 1 byte interrupt port. The fourth port is a signal port to receive data. The fifth to eighth ports are data bus lines. Finally, the ninth port is a port to sense whether a door is open.

Both a signal of a data transmission available zone belonging to the signal converting unit 13 and a signal of a data transmission available zone belonging to the microcomputer 15 are alternately input to the microcomputer 15 through the first port. In other words, if a high signal is applied through the first port, the signal of the data transmission available zone belonging to the signal converting unit 13 is applied to the microcomputer 15. On the other hand, if a low signal is applied through the first port, the signal of the data transmission available zone belonging to the microcomputer 15 is input to the microcomputer 15.

Subsequently, if the signal period input through the first port is the data transmission available zone of the signal converting unit 13, a signal of the second port is transited from low level to high level. This signal is maintained at high level for a constant time period, and then is transited to low level when it is applied to the microcomputer 15.

Furthermore, when a signal input to the microcomputer 15 through the third port is high, the third port acts as a data reading period.

When a low signal is input to the microcomputer 15 through the fourth port, the microcomputer 15 recognizes a state that it is completed to be ready to read data. Also, when a high signal is input to the microcomputer 15 through the fourth port, the microcomputer 15 recognizes a state that it is completed to read data.

Meanwhile, if a high signal is applied through the ninth port, the microcomputer 15 senses a state that the door is open. If a low signal is applied through the ninth port, the microcomputer 15 senses a state that the door is close.

As described above, the Internet microwave oven of the present invention converts the information searched by the search engine 12 to the signal that can be recognized by the microcomputer 15, at the signal converting unit 13. Then, the Internet microwave oven is controlled to cook food depending on the searched information through the data communication between and stores desired information by downloading.

As aforementioned, the Internet microwave oven according to the present invention has the following advantages.

Since the Internet access is possible without a separate unit, convenience can be provided to the user. Furthermore, since the user can obtain various cooking information, it is possible to variously cook food. Finally, since the user can obtain other various information in addition to the cooking information, the microwave oven can be utilized for various purposes of use.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An Internet microwave oven comprising:
an access unit connected to a communication line, for accessing Internet;
a search engine for searching cooking information and other various information when the Internet is accessed through the access unit;
a microcomputer for downloading the cooking information and other various information searched by the search engine at a user's request or for outputting a control signal to cook food depending on the cooking information selected by the user;
a signal converting unit for converting the cooking information and other various information searched by the search engine to a signal capable of being recognized by the microcomputer to perform data communication with the microcomputer; and
a display unit for displaying the cooking information and other various information converted by the signal converting unit in accordance with the control signal of the microcomputer.

2. The Internet microwave oven of claim 1, wherein the access unit is a modem.

3. The Internet microwave oven of claim 1, wherein the search engine is an Internet browser.

4. The Internet microwave oven of claim 1, wherein the display unit is a liquid crystal display (LCD).

5. The Internet microwave oven of claim 1, wherein the microcomputer recognizes a data transmission zone of the signal converting unit if a high signal is applied to the microcomputer, while the microcomputer recognizes a data transmission zone of the microcomputer if a low signal is applied to the microcomputer.

6. The Internet microwave oven of claim 1, wherein the search engine and the signal converting unit perform data communication in accordance with RS-232C communication standards.
